(19) United States
(12) Patent Application Publication
(10) Pub. No.: US 2006/0250982 A1
(43) Pub. Date: Nov. 9, 2006

(54) Methods and systems for discovering and configuring network devices

(75) Inventors: James Yuan, Colebrook, CT (US); James P. Krul, Glastonbury, CT (US); Gary E. Lavelle, Avon, CT (US)

Correspondence Address: MICHAEL BEST & FRIEDRICH, LLP, 100 E WISCONSIN AVENUE, MILWAUKEE, WI, 53202, US

(73) Assignee: Harrow Products LLC, Montvale, NJ (US)

(21) Appl. No.: 11/122,378

(22) Filed: May 5, 2005

(51) Int. Cl. H04L 12/28; H04L 12/56

(52) U.S. Cl. 370/254; 370/389

(57) ABSTRACT

Methods and systems for discovering a device connectable to a network. One method may include attempting to obtain a dynamic address for the device; creating a first default address for the device, if the dynamic address for the device cannot be obtained; assigning the dynamic address as a network address of the device, if the dynamic address is obtained; assigning the first default address as a network address of the device, if the dynamic address is not obtained; attempting to obtain an address of a discovery device; creating a second default address for the device based upon the address of the discovery device, if the dynamic address for the device was not obtained; assigning the second default address as the network address for the device; and reporting the network address of the device to the discovery device.

### BACKGROUND OF THE INVENTION

When connecting one or more devices on a network or on one or more networks interconnected to create an internet, each device (and interconnected network) requires an identifying number so that it can be distinguished from the other devices (and interconnected networks). Internet Protocol (“IP”) internets, such as the Internet or World Wide Web, use IP addressing to assign a unique address to each device and each interconnected network. An IP address consists of 32 bits specifying both a network and a host or device. Depending on the size and configuration of the internet, different formats of IP addresses may be used. For example, class A IP addresses designate 7 bits to identify the network and 24 bits to designate the host. Class A IP addresses are typically used for internets with few networks with a large number of hosts or devices connected on each network. Class B IP addresses provide 14 bits to specify the network and 16 bits to specify the host, and are often used in internets with a medium number of network and a medium number of hosts on each network. Likewise, class C IP address allocate 21 bits for identifying the network and 8 bits for identifying the host and are typically used for internets containing many networks where each network has only a few hosts.

The host portion of the address may be further broken down to specify a subnet, or a network (i.e., a local area network) within a larger network or internet. Devices connected on a subnet share a common network address component. For example, all devices with an IP address prefix of 192.168.xxx.xxx are on the same subnet. The subnet portion allows a network to contain individual networks while still appearing as one single network to the rest of the internet. Routers connecting networks and subnets use the subnet portion of the IP address to deliver data to the correct smaller network or subnet within a network. For example, the network portion of an IP address may specify a network of a corporation, the subnet portion may specify a network or subnet within the corporation, and the host portion may specify a workstation, printer, or other network devices connected to the network or subnet. Routers and gateways may use subnet masks to determine which subnet a destination device is contained on. In effect, the subnet mask erases the part of the host portion that refers to the actual host device and leaves a subnet number.

### SUMMARY OF THE INVENTION

Finding an intuitive and friendly method to discover and configure a group of devices connected on a network can be a challenge. Organizing a network can require extensive knowledge and training on network behavior and characteristics as well as time and effort. Since each device requires a unique address before it can send or receive information on the network, assigning an IP address to each device is an important and daunting task. Traditionally, network designs used static IP addresses that are manually set at each connected device by a system administrator. Static IP addresses simplify the network device's operation by eliminating the need to seek out an address. Static IP address, however, increase pre-installation planning and installation costs and limit a system administrator's ability to manage and reconfigure the network. The system administrator cannot reuse assigned IP addresses and cannot change the network structure freely since particular changes, such as changing a subnet identifier or switching to a new IP address format due to network growth, would require the manual reassignment of all IP addresses. The system administrator would have to physically visit each connected device and manually reset its IP address.

Dynamic IP addresses, on the other hand, are automatically assigned as needed from a pool of available addresses without interaction from a system administrator. Dynamic addresses may also be reassigned throughout the operation of the device. Dynamic address of often assigned by a dynamic host configuration protocol (“DHCP”) server. Using dynamic IP addresses allows system administrators more freedom since they only need to change the pool of available addresses assigned by the DHCP server to change the addresses for the entire network. With dynamic IP addresses, however, the connectable device must be pre-configured to know how and where to obtain an address from, and any changes to the DHCP may affect the installation procedure preinstalled in the device.

Regardless of the type of addresses used, the initial state of the device from the factory traditionally must be set to one type of addressing protocol or the other. If the device is set to attach to a network using dynamic IP addressing and the device is either attached to a network not using dynamic IP addressing or is attached to a network using dynamic IP addressing but is unable to obtain an address, the device may not operate correctly or at all. Alternatively, if the device is set to attach to a network using static IP addressing, the pre-assigned IP address may conflict with the address of current or future device on the network or the address format or subnet structure of the network.

One possible solution to the above-identified problem is to prompt an installer or user for an indication of the type of network the device is attached to, but the installer may be unaware of the current addressing scheme of the network and may also not be notified of changes to the addressing scheme in the future that may require the reconfiguration of the attached device. The network device may also default to a random static address if a dynamic address is not obtained, but there is no absolute guarantee that the randomly selected address is not already being used in the network. The network device may also default to a static address that places the device on a network or subnet where it cannot properly or efficiently function or communicate with other devices.

Due to the problems addressed above, it would be beneficial to provide an method of discovering and configuring devices attached to a network regardless of the addressing scheme used by the network.

Some embodiments of the invention therefore provide methods of discovering a device connectable to a network. One method may include attempting to obtain a dynamic address for the device; creating a first default address for the device, if the dynamic address for the device cannot be obtained; assigning the dynamic address as a network address of the device, if the dynamic address is obtained; assigning the first default address as a network address of the device, if the dynamic address is not obtained; attempting to obtain an address of a discovery device; creating a second default address for the device based upon the address of the discovery device, if the dynamic address for the device was not obtained; assigning the second default address as the network address for the device; and reporting the network address of the device to the discovery device.

Additional embodiments provide systems for discovering a device connectable to a network. One system may include the device configured to attempt to obtain a dynamic address, to create a first default address if the dynamic address cannot be obtained, to verify the first default address, to modify the first default address if the first default address is not verified, to assign the dynamic address as a network address if the dynamic address is obtained, to assign the first default address as a network address if the dynamic address is not obtained, to attempt to obtain an address of a discovery device, to create a second default address for the device based upon the address of the discovery device if the dynamic address for the device was not obtained and the address of discovery device was obtained, to assign the second default address as the network address for the device, and to report the network address of the device to the discovery device; and a discovery device having an address and configured to receive the network address of the device.

Yet other embodiments provide computer-readable medium that contains instructions for discovering a device connectable to a network. The computer-readable medium may include instructions for attempting to obtain a dynamic address for the device; creating a first default address for the device, if the dynamic address for the device cannot be obtained; assigning the dynamic address as a network address of the device, if the dynamic address is obtained; assigning the first default address as a network address of the device, if the dynamic address is not obtained; attempting to obtain an address of a discovery device; creating a second default address for the device based upon the address of the discovery device, if the dynamic address for the device was not obtained; assigning the second default address as the network address for the device; and reporting the network address of the device to the discovery device.

Other features and aspects of embodiments of the invention will become apparent to those skilled in the art upon review of the following detailed description, claims, and drawings.

### BRIEF DESCRIPTION OF THE DRAWINGS

In the drawings:

FIG. 1 illustrates an exemplary network.

FIGS. 2-4 are a flow charts describing an exemplary process of automatically obtaining an address for a device connected to a network.

FIG. 5 is a flow chart describing an exemplary process of operating a discovery device.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

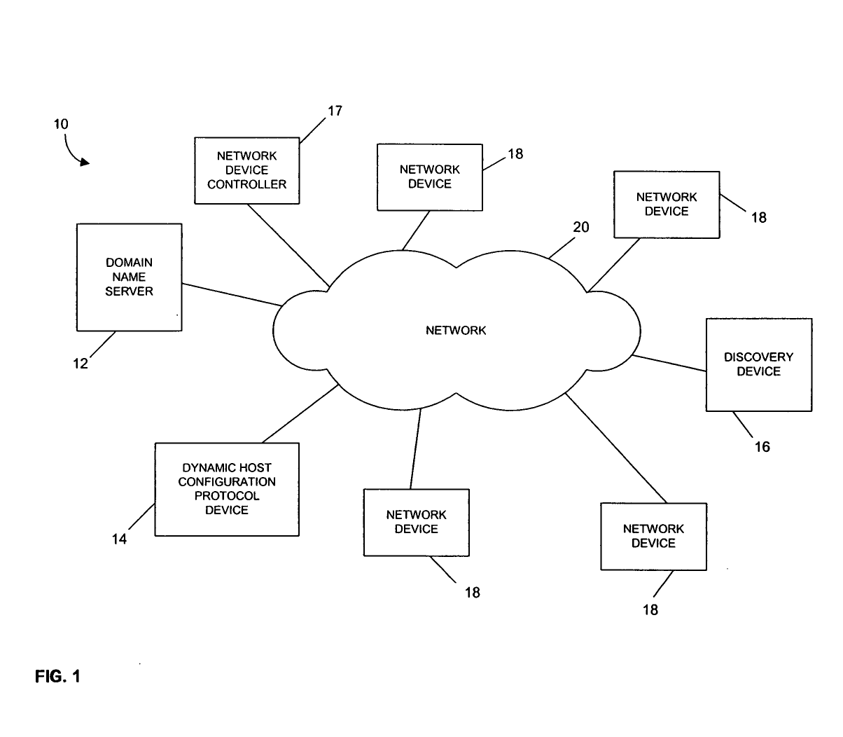

FIG. 1 illustrates an exemplary system 10 for networking a number of devices. The system 10 includes a domain name server (“DNS”) 12, a dynamic host configuration protocol (“DHCP”) server 14, a discovery device 16, a network device controller 17, one or more network devices 18, and a network 20 connecting the components. The DNS 12 functions as an IP address directory and provides IP addresses of devices connected to the network 20 so that information can be addressed and routed to the appropriate destination. Devices connected to the network 20 can query the DNS 12 for the IP addresses of other devices also connected to the network 20.

The DHCP device 14 dynamically assigns IP addresses to devices that are connected to the network 20. The DHCP device 14 may issue permanent or temporary addresses to connected devices from a pool of available addresses. Issued addresses may be associated with a time duration that specifies an amount of time or uses that the address will remain valid. A device may be required to obtain multiple address during the course of its operation. The DHCP device 14 may also notify the DNS 12 of assigned addresses so that information can be properly addressed and routed to the device. The functionality provided by the DHCP device 14 and DNS 12 may also be combined into a single device that dynamically allocates addresses, records address assignments, and provides address information to querying devices. It should be understood that the system 10 may include multiple DNSs 12 and/or DHCP devices. It should also be understood that some networks may not provide DHCP functionality. Without DHCP functionality, the network 20 may become a static addressing network and the IP address of each device connected on the network 20 must be set manually by a system administrator or by an alternate device connected to the network 20.

In some embodiments, the discovery device 16 functions as a server that provides configuration and operational information to one or more of the network devices 18. The discovery device 16 may also keep track of the network devices 18 attached to the network 20. In some embodiments, the discovery device 16 contains hardware and software compliant to the IEEE 802.3 (Ethernet) 10/100 BaseT standard and that supports Internet Group Member Protocol (“IGMP”) and multicasting. The discovery device 16 may also use other hardware and transport protocols.

In some embodiments, each network device 18 has at least a power supply, a transceiver for a network connection, non-volatile memory and a microprocessor, and one or more input/output ports for receiving/transmitting data. In some embodiments, one or more of the network devices 18 may be a secure access device such as a credential reader, electronic key input, or the like, and may include, in addition to the components listed above, a locking device that is mechanically connected to a secure point such as a door or cabinet. The network devices 18 may manage the doors and/or cabinets in a building and may each be connected to the network 20. Connecting the network device 18 to the network 20 may allow the access, operation, and status of secure points to be monitored and recorded. The network device controller 17 may query and/or receive status information from each of the network devices 18 and may also generate control signals to one or more of the network devices 18. For example, in the case of a robbery, fire, or other emergency, the network device controller 17 may broadcast a control signal to every device 18 causing the all secure points to be locked down until further notice. The network device controller 17 may also store all credentials provided to the credential readers and an associated timestamp to keep a log of all individuals entering and/or exiting a room or building. In some embodiments, the functionality provided by the network device controller 17 may be incorporated with the functionality provided by the discovery device 16 as a single component. Also, as indicated for the discovery device 16, in some embodiments, the network devices 18 and the network device controller 17 contain hardware and software compliant to the IEEE 802.3 (Ethernet) 10/100 BaseT standard and supporting the Internet Group Member Protocol (“IGMP”) and multicasting. Other hardware and transport protocols may also be used.

The network 20 connecting the components of the system 10 may be a Transmission Control Protocol/Internet Protocol (“TCP/IP”) compliant network. The network 20 may include one or more local area networks (“LANs”) and may be connected to form a larger wide area network (“WAN”) or internet. Each LAN may be a high-speed LAN based on Ethernet methodologies. The LANs may utilize coaxial cable, twisted pair, or optical fiber as connection medium.

It should be understood that the system 10 may include other components and devices such as routers, gateways, servers, printers, workstations, and the like, that are also connected to the network 20.

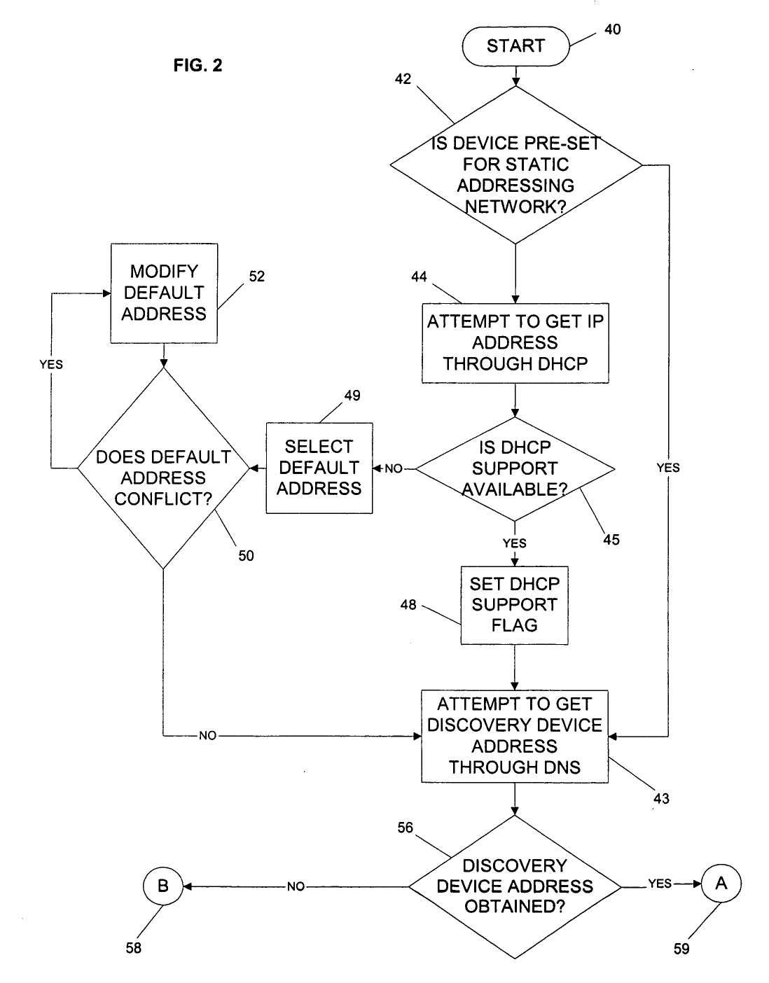

FIG. 2 is a flow chart illustrating an exemplary method of discovering and configuring the network devices 18 attached to the network 20. Starting at block 40, the network device 18 is initially connected to the network 20 or is being reconfigured after previously being connected. The network device 18 first determines if it is preset for a particular type of addressing network (block 42). For example, when manufactured the network device 18 may be configured to operate in a static addressing network or a dynamic addressing network. The network device 18 may include a static flag that may be set to indicate that the network device 18 is pre-configured to operate in a static addressing network and may also have a corresponding preset static address assigned to it. The network device 18 may also be configured to prompt a system administrator for a static address when the static flag is set. If the network device 18 is configured to operate in a particular type of addressing network, such as a static addressing network, the network device 18 may not need to attempt to acquire an address and may directly proceed to attempting to communicate with the discovery device 16 at block 43. The process of communicating with the discovery device 16 will be explained in detail below.

If, on the other hand, the network device 18 is not pre-configured for a particular addressing network, the network device 18 attempts to obtain an IP address from the DHCP server 14. The network device 18 may transmit or broadcast an address request and may wait to receive a return address offer. For example, the network device 18 may transmit or broadcast an address requests three times in a thirty second time interval before deciding whether DHCP support, the DHCP server 14, exists in the system 10. If the network device 18 does not receive a return offer within a particular period of time, the network device 18 can determine that DHCP support is not available (block 45). However, if the network device 18 receives a return address offer, which includes a dynamic network address, within the designated amount of time, DHCP support is available and the network device 18 indicates the availability of DHCP support by setting a DHCP support flag (block 48). The DHCP support flag may be referred later to determine whether DHCP support was available and whether the network device 18 obtained a dynamic network address.

If an address offer was not returned to the network device 18 within the preset amount of time, indicating that DHCP support was not available, the network device 18 may use a default network address (block 49). The default network address may be chosen from a range of recommended address that are generally restricted from everyday use. For example, the address may be chosen from addresses ranging from 192.168.0.0 to 192.168.255.255. The device 18 may also have a designated subnet mask which specifies a particular subnet for the device 18. For example, subnet mask 255.255.255.0 may be associated with the chosen default address for the device 18. It should be noted that other valid address ranges and subnet mask values may be used to determine a default address.

After a default address is chosen for the device 18, the device 18 determines if the default address conflicts with any preexisting addresses assigned on the network 20 (block 50). Although the default address may have chosen from the range of recommended addresses, another device connected to the network 20 may have also been unable to locate DHCP support and may have selected the same default address. The device 18 may check that its default address does not conflict with other addresses on the network using the address resolution protocol (“ARP”). Using ARP the device 18 sends a multicast message to all devices connected to the network 20 specifying the address chosen. If another device on the network 20 has the same address as stated in the multicast message, it will respond to the network device 18. Therefore, if the network device 18 does not receive a return message from another device connected on the network 20 the network device 18 can generally assume that its default address does not conflict with the address of another device on the network 20.

If on the other hand, the network device 18 does receive a return message, the network device 18 knows that its default address does conflict with the address of another device and the network device 18 modifies its default address (block 52). The device 18 may modify its default address by increasing or decreasing its original default address by a given amount or may randomly chose another address from the range of recommended default addresses. After modifying its default address the device 18 checks that the modified address does not conflict with the address of another device on the network 20 at block 50. It should be understood that other ways of verifying the default address may be used other than ARP. For example, the network device 18 may request unique address verification from the DNS 12, which records all address assignments. Once the device 18 has a default network address that does not conflict with the address of another device connected to the network 20, the network device 18 is ready to attempt to communicate with the discovery device 16 at block 43.

In order to communicate with the discovery device 16, the network device 18 needs the IP address of the discovery device 16. At block 43, the network device 18 attempts to obtain the address of the discovery device 16. In some embodiments, the network device 18 may request the address of the discovery device 16 from the DNS 12. The address of the discovery device may also be supplied by the DHCP server 14 or may be preprogrammed into the network device 18. For example, if the static flag of the network device 18 is set, the address of the discovery device 16 may be preprogrammed into the network device 18 or may be entered by the system administrator when the static address of the network device 18 is supplied.

At block 56, the network device 18 determines whether it successfully obtained the address of the discovery device 16. If the network device 18 was able to obtain the address of the discovery device 16, the device 18 proceeds to connecting reference point B (block 58). Otherwise, if the address was not obtained, the network device 18 proceeds to connecting reference point A (block 59).

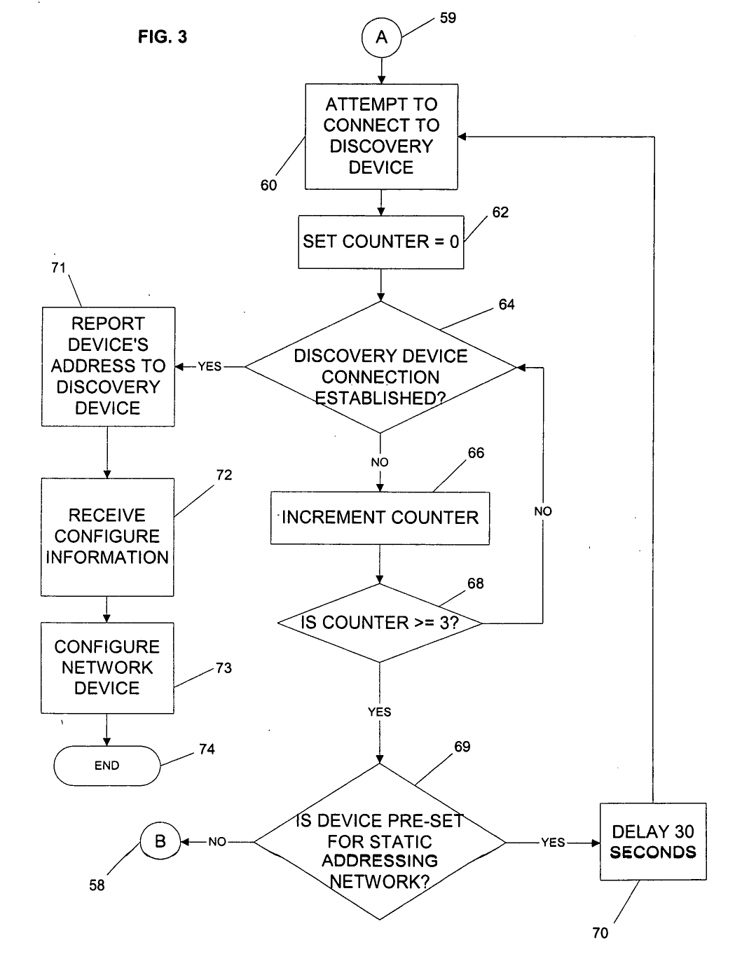

Connecting reference point A (block 59), continued on FIG. 3, is followed when the network device 18 successfully obtains the address for the discovery device 16. At block 60, the network device 18 attempts to connect to the discovery 16. Using the address obtained, the network device 18 sends a connection request message to the discovery device 16 and waits for a reply. At block 62, the network device 18 sets a counter to 0. The counter will be used to track the number of connection attempts performed by the network device 18.

At block 64, the network device 18 determines whether a connection was successfully established with the discovery device 16. If the network device 18 did not receive a reply from the discovery device 16, a successful connection was not established between the network device 18 and the discovery device 16, and the network device 18 increments the counter to record that an unsuccessful connection attempt was performed (block 66). The network device 18 then determines whether another attempt should be tried at block 68. The network device 18 may continue to attempt to connect to the discovery device 16 until a preset number of unsuccessful attempts have been made or until a predetermined amount of time has transpired. For example, while the network device 18 has made less than three unsuccessful attempts, the network device 18 may return to block 64 and perform another connection attempt. If, however, the network device 18 has made three or more unsuccessful connection attempts, the network device 18 may determine whether it should wait a predetermined amount of time and then continue trying or should attempt to re-obtain an address of the discovery device 16 (block 69). For example, if the static flag of the network device 18 is set, the network device 18 may delay 30 seconds at block 70 and then may return to block 60 and again attempt to connect to the discovery device 16. It should be understood that the network device 18 may delay a longer or shorter time and may also prompt a system administrator to re-enter the address of the discovery device 16 in case the previously obtained address was either erroneously entered or has changed. Else, the network device 18 may proceed to connecting reference point B (block 58). It should be understood that in some embodiments, the network device 18 may always proceed to connecting reference point B regardless of whether the static flag has been or the network device 18 has be pre-configured for a particular type of addressing network. Connecting reference point B (block 58) will be discussed in detail below.

If, however, while attempting to connect to the discovery device 16 at block 60, the network device 18 receives a reply message from the discovery device 16, a connection has been established (block 64) and the network device 18 supplies identification information to the discovery device (block 71). The network device 18 may report its network address; its unique serial number, a media access control (“MAC”), or hardware address that uniquely identifies the network device 18; and/or other information that the discovery device 16 may use to configure the device 18. The network device 18 may also provide information to the discovery device 16 regarding the manner in which the device's address was obtained. For example, the network device 18 may supply the value of the DHCP support flag to the discovery device 16. If the flag is set, the discovery device 16 knows that the network device 18 received a dynamic network address from the DHCP server 14. If, however, the DHCP support flag is not set, the discovery device 16 knows that the network device 18 is using a default address as its network address and the discovery device 16 may provide DHCP support and send a dynamic network address to the network device 18 to receive the default network address.

After receiving the identification information from the network device 18, the discovery device 16 sends configuration information back to the network device 18 at block 72. The discovery device 18 may also send information to other components of the system 10 including the DNS 12, the DHCP server 14, the network device controller 17, and like. For example, the discovery device 18 may provide the network device controller 17 with information regarding the network device 18 (i.e., the network address of the network device 18) so that the network device controller 17 can control and track the operation of the device 18. The discovery device 16 may also provide address information to the DNS 12 and/or DHCP server 14 so that a valid address can be associated with the network device 18 and other devices attached to the network 20 are not assigned a conflicting address.

At block 73, the network device 18 configures itself according to the received configuration information, and the discovery and configuration process is terminated (block 74).

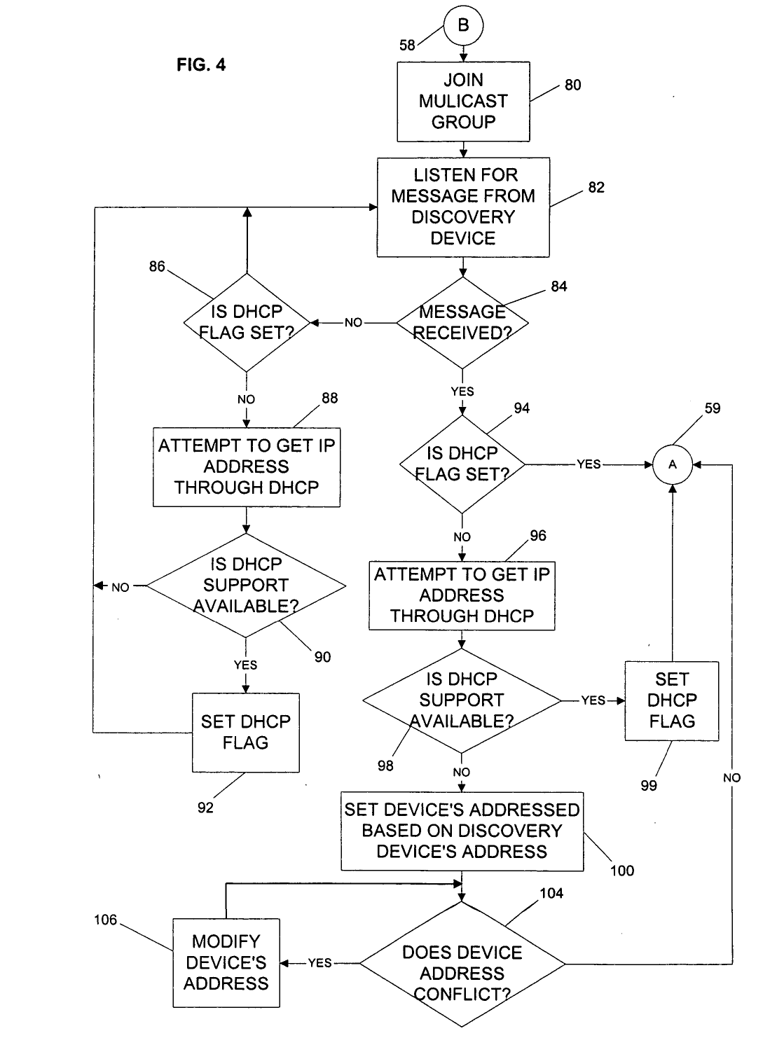

Connecting reference point B (block 58), continued on FIG. 4, is followed either when an address for the discovery device 16 cannot be obtained or when an address for the discovery device 16 is obtained but a connection cannot be established. At block 80, the network device 18 joins a multicast group. All members of a multicast group receive any message addressed to the multicast group. Multicast groups are a mechanism for sending a single message to multiple recipients or destinations. Multicast groups are a part of the IGMP protocol, which is well known in the art and is therefore not discussed in detail. The multicast group that the network device 18 joins represents a group that the discovery device 16 broadcasts, or multicasts, messages to. The messages sent by the discovery device 16 may include the address of the discovery device 16, which the network device 18 can use to establish a connection with the discovery device 16 and report its existence.

After joining the multicast group, the network device 18 listens for, or waits to receive, a message from the discovery device 16 addressed to the multicast group (block 82). Continuously while the network device 18 checks for multicast messages (block 84) or at designated time intervals, (i.e., every five minutes) the network device 18 checks if the DHCP flag has been set (block 86). The DHCP flag indicates whether the network device 18 obtained a dynamic network address or is assigned a default network address. If the DHCP flag is set, the network device 18 already has obtained a dynamic network address and may continue listening for multicast messages at block 82. If, however, the DHCP flag has not been set, the network device 18 is currently assigned a default network address, and the network device 18 may reattempt to receive DHCP support to obtain a dynamic address at block 88 as described above while waiting for messages from the discovery device 16. If DHCP support is available and the network device 18 receives a dynamic network address from the DHCP server 14 (block 90), the network device 18 sets the DHCP flag at block 92, which will stop the network device 18 from continuously attempting to obtain a dynamic network address. The network device then returns to waiting for a broadcast message at block 82. If DHCP support is still not available, however, the network device 18 continues waiting for multicast messages from the discovery device 16 at block 82 without setting the DHCP flag and ultimately continues to attempt to receive DHCP support until either it successfully receives DHCP support or a multicast message from the discovery device 16. The network device 18 may also use a timer or counter to track the amount of time or attempts made and may generate an error message or warning if either DHCP support cannot be obtained or a multicast message is not received after a given time period or after a given number of attempts.

Once the network device 18 receives a multicast message containing the address of the discovery device 16 at block 84, the network device 18 again checks the DHCP flag (block 94). If the DHCP flag is set, the network device 18 proceeds to connecting reference point A (block 59) where the network device attempts to establish a connection with the discovery device 16 (see FIG. 3).

Else, if the DHCP flag is not set, the network device 18 attempts once more to obtain a dynamic network address as described above for FIG. 2 at block 96. At block 98, the network device determines if DHCP support is available. If DHCP support and a dynamic address was obtained, the network device 18 sets the DHCP flag at block 99 and proceeds to connecting reference point A (block 59) where it will attempt to establish a connection with the discovery device 16 using the newly obtained address of the discovery device 16 (refer to FIG. 3).

If, however, DHCP support is not available and the network device 18 does not obtain a dynamic network address, the network device 18 dynamically configures its default network address based on the address of the discovery device 16 received in the multicast message (block 100). The network device 18 may change its default network address so that it is on the same network or subnet that the discovery device 16 as indicated by the address of the discovery device 16. After modifying its default network address, the network device 18 again checks for conflicting addresses on the network 20 at block 104. While the modified network address conflicts with other addresses on the network 20, the network device 18 changes the modified network address at block 106 and rechecks for conflicts at block 104 until it finds a valid address. Once the network device 18 has a valid network address, the device 18 proceeds to connecting reference point A (block 59) where it will attempt to establish a connection with the discovery device 16 as described for FIG. 3.

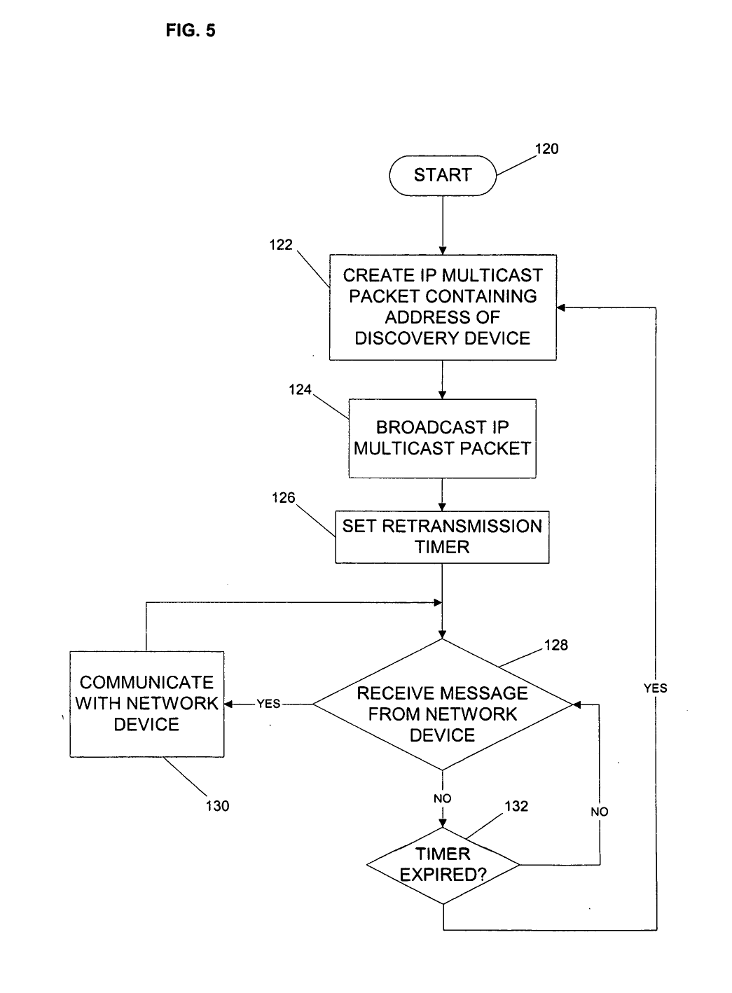

FIG. 5 illustrates an exemplary discovery and configuration process executed by the discovery device 16. Starting at block 120, the discovery device 16 creates an IP multicast message containing the address of the discovery device 16. The discovery device 16 may receive its network address dynamically from the DHCP server 14 or statically by a system administrator or other administrative device. The IP multicast message may also contain the port number, or logical end point of the discovery device's connection to the network 20, and/or other discovery or configuration information required by the network devices 18 to establish a connection with the discovery device 16. The IP multicast message will be delivered to all devices that are part of the multicast group to which the IP multicast message is addressed. The discovery device 16 may optionally encrypt the multicast messages so only devices configured with the corresponding decryption functionality can obtain the information included in the IP multicast message. The broadcast group address may be pre-configured in the discovery device 16 and each network device 18.

At block 124, the discovery device 16 transmits, or multicasts, the IP multicast message. The IP multicast message is sent not only to the network or subnet that the discovery device 16 is physically attached to but is sent to other networks and subnets which contain devices that are part of the broadcast group to which the IP multicast message is addressed to. By traveling further than just the network physically containing the discovery device 16, the discovery device 16 can configure devices that are not on the same network and/or subnet as the discovery device 16.

After sending the IP multicast message, the discovery device 16 starts a retransmission timer at block 126. The retransmission timer may be used to track the amount of time since sending the last IP multicast message.

At block 128, the discovery device 16 determines if it has received a message from one of the network devices 18. The message may be a connection request and/or may contain the address or other identifying information of one of the network devices 18. The discovery device 16 uses the information received in the message to establish a connection with and/or configure the network device 18 that sent the message (block 130). As previously indicated, the discovery device 16 may also report received identifying information to the DNS 12, DHCP 14, and/or network device controller 17.

While waiting to receive messages from the network devices 18, the discovery device 16 checks if the retransmission timer has expired (block 132). If the timer has not expired, the discovery device 16 continues to wait and check for messages at block 128. If the timer has expired, however, the discovery device 16 return to block 122 and recreates and retransmits another IP multicast message. The discovery device 16 continuously executes the above loop discovering and configuring network devices 18.

As should be apparent to one of ordinary skill in the art, the systems and components shown in the figures are models of what actual systems might be like. Many of the components described are capable of being implemented in software executed by a microprocessor or a similar device or of being implemented in hardware using a variety of components including, for example, application specific integrated circuits (“ASICs”). The functionality provided by the components may also be combined and distributed in other constructions other than those explicitly illustrated and described. Also, as previously stated, the systems presented above may contain other components and are not limited to the structured presented.

Various features and advantages of the invention are set forth in the following claims.

1. A method of discovering a device connectable to a network, the method comprising:
attempting to obtain a dynamic address for the device;
creating a first default address for the device, if the dynamic address for the device cannot be obtained;
assigning the dynamic address as a network address of the device, if the dynamic address is obtained;
assigning the first default address as a network address of the device, if the dynamic address is not obtained;
attempting to obtain an address of a discovery device;
creating a second default address for the device based upon the address of the discovery device, if the dynamic address for the device was not obtained;
assigning the second default address as the network address for the device; and
reporting the network address of the device to the discovery device.

2. A method as claimed in claim 1, further comprising receiving configuration instructions from the discovery device.

3. A method as claimed in claim 1, further comprising joining an Internet Protocol multicasting group.

4. A method as claimed in claim 3, further comprising receiving an Internet Protocol multicast message from the discovery device, the Internet Protocol multicast message including the address of the discovery device.

5. A method as claimed in claim 1, further comprising verifying the first default address.

6. A method as claimed in claim 5, further comprising modifying the first default address, if the first default address is not verified.

7. A method as claimed in claim 1, further comprising verifying the second default address.

8. A method as claimed in claim 7, further comprising modifying the second default address if the second default address is not verified.

9. A method as claimed in claim 1, further comprising creating a first default address between 192.168.0.0 and 192.168.255.255 with a subnet mask of 255.255.255.0.

10. A method as claimed in claim 1, further comprising obtaining the address of the discovery device from a domain name server.

11. A method as claimed in claim 1, further comprising attempting to obtain a dynamic address for the device after obtaining the address of the discovery device if a dynamic address for the device was not previously obtained.

12. A method of discovering a secure access device connectable to a network, the method comprising:
attempting to obtain a dynamic address for the secure access device;
creating a first default address for the secure access device, if the dynamic address for the secure access device cannot be obtained;
assigning the dynamic address as a network address of the secure access device, if the dynamic address is obtained;
assigning the first default address as a network address of the secure access device, if the dynamic address is not obtained;
attempting to obtain an address of a discovery device;
creating a second default address for the secure access device based upon the address of the discovery device, if the dynamic address for the secure access device was not obtained;
assigning the second default address as the network address for the secure access device; and
reporting the network address of the secure access device to the discovery device.

13. A method as claimed in claim 12, further comprising receiving configuration instructions from the discovery device.

14. A method as claimed in claim 12, further comprising joining an Internet Protocol multicast group.

15. A method as claimed in claim 14, further comprising receiving an Internet Protocol multicast message from the discovery device, the Internet Protocol multicast message including the address of the discovery device.

16. A method as claimed in claim 12, further comprising verifying the first default address.

17. A method as claimed in claim 16, further comprising modifying the first default address, if the first default address is not verified.

18. A method as claimed in claim 12, further comprising verifying the second default address.

19. A method as claimed in claim 18, further comprising modifying the second default address if the second default address is not verified.

20. A method as claimed in claim 12, further comprising creating a first default address between 192.168.0.0 and 192.168.255.255 with a subnet mask of 255.255.255.0.

21. A method as claimed in claim 12, further comprising obtaining the address of the discovery device from a domain name server.

22. A method as claimed in claim 12, further comprising attempting to obtain a dynamic address for the secure access device after obtaining the address of the discovery device if a dynamic address for the secure access device was not previously obtained.

23. A method as claimed in claim 12, further comprising obtaining a dynamic address of a dynamic host configuration protocol server.

24. A system for discovering a device connectable to a network, the system comprising:
the device configured to attempt to obtain a dynamic address, to create a first default address if the dynamic address cannot be obtained, to verify the first default address, to modify the first default address if the first default address is not verified, to assign the dynamic address as a network address if the dynamic address is obtained, to assign the first default address as a network address if the dynamic address is not obtained, to attempt to obtain an address of a discovery device, to create a second default address for the device based upon the address of the discovery device if the dynamic address for the device was not obtained and the address of discovery device was obtained, to assign the second default address as the network address for the device, and to report the network address of the device to the discovery device; and
a discovery device having an address and configured to receive the network address of the device.

25. A system as claimed in claim 24, wherein the discovery device is further configured to provide configuration instructions to the device.

26. A system as claimed in claim 25, wherein the device is further configured to receive configuration instructions from the discovery device.

27. A system as claimed in claim 24, wherein the discovery device is further configured to generate an Internet Protocol multicast message including the address of the discovery device.

28. A system as claimed in claim 27, wherein the device is further configured to join an Internet Protocol multicast group if the address of the discovery device is not obtained.

29. A system as claimed in claim 28, wherein the device is further configured to receive an Internet Protocol multicast message from the discovery device, the Internet Protocol multicast message including the address of the discovery device.

30. A system as claimed in claim 24, wherein the device is further configured to verify the second default address.

31. A system as claimed in claim 30, wherein the device is further configured to modify the second default address if the second default address is not verified.

32. A system as claimed in claim 24, further comprising a dynamic host configuration server configured to provide the dynamic address to the device.

33. A system as claimed in claim 24, further comprising a domain name server configured to provide the address of the discovery device to the device.

34. A system as claimed in claim 24, wherein the device is further configured to create a first default address between 192.168.0.0 and 192.168.255.255 with a subnet mask of 255.255.255.0.

35. A security system for discovering a secure access device connectable to a network, the security system comprising:
the secure access device configured to attempt to obtain a dynamic address, to create a first default address if the dynamic address cannot be obtained, to verify the first default address, to modify the first default address if the first default address is not verified, to assign the dynamic address as a network address if the dynamic address is obtained, to assign the first default address as a network address if the dynamic address is not obtained, to attempt to obtain an address of a discovery device, to create a second default address for the secure access device based upon the address of the discovery device if the dynamic address for the secure access device was not obtained and the address of discovery device was obtained, to assign the second default address as the network address for the secure access device, and to report the network address of the secure access device to the discovery device;
a discovery device having an address and configured to receive the network address of the secure access device; and
the network configured to utilize the Transmission Control Protocol/Internet Protocol.

36. A security system as claimed in claim 35, wherein the discovery device is further configured to provide configuration instructions to the secure access device.

37. A security system as claimed in claim 36, wherein the secure access device is further configured to receive configuration instructions from the discovery device.

38. A security system as claimed in claim 35, wherein the discovery device is further configured to generate an Internet Protocol multicast message including the address of the discovery device.

39. A security system as claimed in claim 38, wherein the secure access device is further configured to join an Internet Protocol multicast group if the address of the discovery device is not obtained.

40. A security system as claimed in claim 39, wherein the secure access device is further configured to receive an Internet Protocol multicast message from the discovery device, the Internet Protocol multicast message including the address of the discovery device.

41. A security system as claimed in claim 35, wherein the secure access device is further configured to verify the second default address.

42. A security system as claimed in claim 41, wherein the secure access device is further configured to modify the second default address if the second default address is not verified.

43. A security system as claimed in claim 35, further comprising a dynamic host configuration server configured to provide the dynamic address to the secure access device.

44. A security system as claimed in claim 35, further comprising a domain name server configured to provide the address of the discovery device to the secure access device.

45. A security system as claimed in claim 35, wherein the secure access device is further configured to create a first default address between 192.168.0.0 and 192.168.255.255 with a subnet mask of 255.255.255.0.

46. Computer-readable medium comprising instructions for discovering a device connectable to a network by:
attempting to obtain a dynamic address for the device;
creating a first default address for the device, if the dynamic address for the device cannot be obtained;
assigning the dynamic address as a network address of the device, if the dynamic address is obtained;
assigning the first default address as a network address of the device, if the dynamic address is not obtained;
attempting to obtain an address of a discovery device;
creating a second default address for the device based upon the address of the discovery device, if the dynamic address for the device was not obtained;
assigning the second default address as the network address for the device; and
reporting the network address of the device to the discovery device.

47. Computer-readable medium as claimed in claim 46, further comprising instructions for receiving configuration instructions from the discovery device.

48. Computer-readable medium as claimed in claim 46, further comprising instructions for joining an Internet Protocol multicasting group.

49. Computer-readable medium as claimed in claim 48, further comprising instructions for receiving an Internet Protocol multicast message from the discovery device, the Internet Protocol multicast message including the address of the discovery device.

50. Computer-readable medium as claimed in claim 46, further comprising instructions for verifying the first default address.

51. Computer-readable medium as claimed in claim 50, further comprising instructions for modifying the first default address, if the first default address is not verified.

52. Computer-readable medium as claimed in claim 46, further comprising instructions for verifying the second default address.

53. Computer-readable medium as claimed in claim 52, further comprising instructions for modifying the second default address if the second default address is not verified.

54. Computer-readable medium as claimed in claim 46, further comprising instructions for creating a first default address between 192.168.0.0 and 192.168.255.255 with a subnet mask of 255.255.255.0.

55. Computer-readable medium as claimed in claim 46, further comprising instructions for obtaining the address of the discovery device from a domain name server.

56. Computer-readable medium as claimed in claim 46, further comprising instructions for attempting to obtain a dynamic address for the device after obtaining the address of the discovery device if a dynamic address for the device was not previously obtained.

57. Computer-readable medium comprising instructions for discovering a secure access device connectable to a network by:
attempting to obtain a dynamic address for the secure access device;
creating a first default address for the secure access device, if the dynamic address for the secure access device cannot be obtained;
assigning the dynamic address as a network address of the secure access device, if the dynamic address is obtained;
assigning the first default address as a network address of the secure access device, if the dynamic address is not obtained;
attempting to obtain an address of a discovery device;
creating a second default address for the secure access device based upon the address of the discovery device, if the dynamic address for the secure access device was not obtained;
assigning the second default address as the network address for the secure access device; and
reporting the network address of the secure access device to the discovery device.

58. Computer-readable medium as claimed in claim 57, further comprising instructions for receiving configuration instructions from the discovery device.

59. Computer-readable medium as claimed in claim 57, further comprising instructions for joining an Internet Protocol multicasting group.

60. Computer-readable medium as claimed in claim 59, further comprising instructions for receiving an Internet Protocol multicast message from the discovery device, the Internet Protocol multicast message including the address of the discovery device.

61. Computer-readable medium as claimed in claim 57, further comprising instructions for verifying the first default address.

62. Computer-readable medium as claimed in claim 57, further comprising instructions for modifying the first default address, if the first default address is not verified.

63. Computer-readable medium as claimed in claim 57, further comprising instructions for verifying the second default address.

64. Computer-readable medium as claimed in claim 63, further comprising instructions for modifying the second default address if the second default address is not verified.

65. Computer-readable medium as claimed in claim 57, further comprising instructions for creating a first default address between 192.168.0.0 and 192.168.255.255 with a subnet mask of 255.255.255.0.

66. Computer-readable medium as claimed in claim 57, further comprising instructions for obtaining the address of the discovery device from a domain name server.

67. Computer-readable medium as claimed in claim 57, further comprising instructions for attempting to obtain a dynamic address for the secure access device after obtaining the address of the discovery device if a dynamic address for the secure access device was not previously obtained.
